(19) United States
(12) Patent Application Publication
(10) Pub. No.: US 2023/0175524 A1
(43) Pub. Date: Jun. 8, 2023

(54) COMPRESSOR HOUSING AND CENTRIFUGAL COMPRESSOR

(71) Applicant: MITSUBISHI HEAVY INDUSTRIES ENGINE & TURBOCHARGER, LTD, Sagamihara-shi, Kanagawa (JP)

(72) Inventors: Kenichiro IWAKIRI, Tokyo (JP); Tadashi KANZAKA, Tokyo (JP); Yutaka FUJITA, Tokyo (JP); Hironori HONDA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 17/922,266

(22) PCT Filed: May 21, 2020
(86) PCT No.: PCT/JP2020/020043

§ 371 Date: Oct. 28, 2022

(51) Int. Cl. F04D 29/44; F04D 17/10

(52) U.S. Cl. CPC F04D 29/441; F04D 17/10

(57) ABSTRACT

A compressor housing internally forms: an inlet passage with an inflow port formed in a shroud surface; an outlet passage with an outflow port formed in an introduction surface formed on a front side of a shroud surface; and a recirculation passage connecting the inlet passage and the outlet passage. An intake air introduction portion of the compressor housing has: a front-side surface defining a front side in the outlet passage; a rear-side surface defining a rear side in the outlet passage; and a front-side introduction surface formed on the front side relative to the outflow port on the introduction surface. Each of the front-side surface, the rear-side surface, and the front-side introduction surface is inclined to the rear side from an outer side toward an inner side in a radial direction, the rear-side surface includes a convex curved portion, and the front-side introduction surface includes an introduction surface-side convex curved portion.

### TECHNICAL FIELD

The present disclosure relates to a compressor housing and a centrifugal compressor including the compressor housing.

### BACKGROUND

A centrifugal compressor used in a compressor part or the like of a turbocharger for an automobile or a ship imparts kinetic energy to a fluid through rotation of an impeller and discharges the fluid outward in the radial direction, thereby achieving a pressure increase of the fluid by utilizing the centrifugal force. Such a centrifugal compressor is provided with various features to meet the need to improve the pressure ratio and the efficiency in a broad operational range.

The centrifugal compressor includes an impeller and a compressor housing for housing the impeller. The impeller guides a fluid (for example, air) having flowed in from a front side in the axial direction to the outer side in the radial direction. In general, the compressor housing internally forms an intake air introduction path for guiding the fluid from the outside of the compressor housing to the front side in the axial direction of the impeller, an impeller chamber in communication with the intake air introduction path for housing the impeller, and a scroll passage in communication with the impeller chamber for guiding a gas having passed through the impeller to the outside of the compressor housing.

Such compressor is required of a wide range for achieving a high pressure ratio over a wide operating range. However, an instability phenomenon called surging may occur in which the fluid vibrates violently in a fluid flow direction, at a low flow rate when the intake flow rate of the compressor is low. In order to avoid surging, the operating range of the compressor at the low flow rate is limited. Thus, a method for suppressing surging has been studied with the aim of achieving wide range in the low flow rate range.

Patent Document 1 discloses a centrifugal compressor that includes a compressor housing which is formed with a recirculation passage connected on one end side to an impeller chamber for housing an impeller and connected on another end side to an intake air introduction path located upstream of the impeller chamber. In such centrifugal compressor, even if the flow rate of a fluid (main flow) flowing from the outside of the compressor housing to the impeller chamber through the intake air introduction path is low, it is possible to increase the flow rate of the fluid sent to an inlet side of the impeller and suppress surging, by returning a part of the fluid in the impeller chamber to the impeller chamber again through the recirculation passage and the intake air introduction path.

### CITATION LIST

### Patent Literature

Patent Document 1: WO2011/099419A

### SUMMARY

### Technical Problem

In the centrifugal compressor that includes the compressor housing formed with the recirculation passage as described in Patent Document 1, if the degree of interference between the above-described main flow and a recirculation flow flowed out from the recirculation passage to the intake air introduction path is high when the recirculation flow joins the main flow, a pressure loss due to the interference between the recirculation flow and the main flow may increase and efficiency of the centrifugal compressor may decrease. Thus, a compressor housing is desired which is capable of decreasing the degree of the interference between the recirculation flow and the main flow and suppressing the occurrence of the pressure loss of the fluid in the compressor housing.

In view of the above, an object of at least one embodiment of the present disclosure is to provide the compressor housing which is capable of suppressing the occurrence of the pressure loss of the fluid in the compressor housing and improving the efficiency of the centrifugal compressor, and the centrifugal compressor including the compressor housing.

### Solution to Problem

A compressor housing according to the present disclosure is a compressor housing for rotatably housing an impeller of a centrifugal compressor, including: a shroud portion which has a shroud surface facing a tip of an impeller blade of the impeller with a predetermined gap; and an intake air introduction portion which has an introduction surface formed on a front side of the shroud surface, the introduction surface defining an intake air introduction path for guiding intake air introduced from an intake port of the compressor housing toward the impeller blade. The compressor housing internally forms: an inlet passage with an inflow port formed in the shroud surface; an outlet passage with an outflow port formed in the introduction surface; and a recirculation passage connecting the inlet passage and the outlet passage. In a cross-sectional view along an axis of the impeller, the intake air introduction portion has: a front-side surface defining a front side in the outlet passage, the front-side surface being inclined to a rear side from an outer side toward an inner side in a radial direction; a rear-side surface defining the rear side in the outlet passage, the rear-side surface being inclined to the rear side from the outer side toward the inner side in the radial direction and including a convex curved portion formed into a convex curved shape at least in part; and a front-side introduction surface formed on the front side relative to the outflow port on the introduction surface, the front-side introduction surface being inclined to the rear side from the outer side toward the inner side in the radial direction and including an introduction surface-side convex curved portion formed into a convex curved shape at least in part.

A centrifugal compressor according to the present disclosure includes the compressor housing.

### Advantageous Effects

According to at least one embodiment of the present disclosure, provided are a compressor housing which is capable of suppressing occurrence of a pressure loss of a fluid in the compressor housing and improving efficiency of a centrifugal compressor, and the centrifugal compressor including the compressor housing.

### BRIEF DESCRIPTION OF DRAWINGS

FIG. 1 is an explanatory view for describing the configuration of a turbocharger including a centrifugal compressor according to an embodiment.

FIG. 2 is a schematic cross-sectional view schematically showing a compressor side of the turbocharger including the centrifugal compressor according to an embodiment, the schematic cross-sectional view including an axis of the centrifugal compressor.

FIG. 3 is an explanatory view for describing an intake air introduction portion according to an embodiment.

FIG. 4 is an explanatory view for describing the intake air introduction portion according to a comparative example.

FIG. 5 is an explanatory view for describing the vicinity of an outlet passage of the intake air introduction portion according to an embodiment.

FIG. 6 is an explanatory view for describing the vicinity of the outlet passage of the intake air introduction portion according to a comparative example.

FIG. 7 is an explanatory view for describing the vicinity of the outlet passage of the intake air introduction portion according to a comparative example.

FIG. 8 is an explanatory view for describing the intake air introduction portion according to an embodiment.

FIG. 9 is an explanatory view for describing the vicinity of the outlet passage of the intake air introduction portion according to an embodiment.

FIG. 10 is an explanatory view for describing the vicinity of the outlet passage of the intake air introduction portion according to an embodiment.

FIG. 11 is an explanatory view for describing a rear-side surface shown in FIG. 10.

FIG. 12 is an explanatory view for describing the intake air introduction portion according to an embodiment.

FIG. 13 is an explanatory view for describing the intake air introduction portion according to an embodiment.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, the expressions “comprising”, “including” or “having” one constitutional element is not an exclusive expression that excludes the presence of other constitutional elements.

The same configurations are indicated by the same reference characters and may not be described again in detail.

(Centrifugal Compressor)

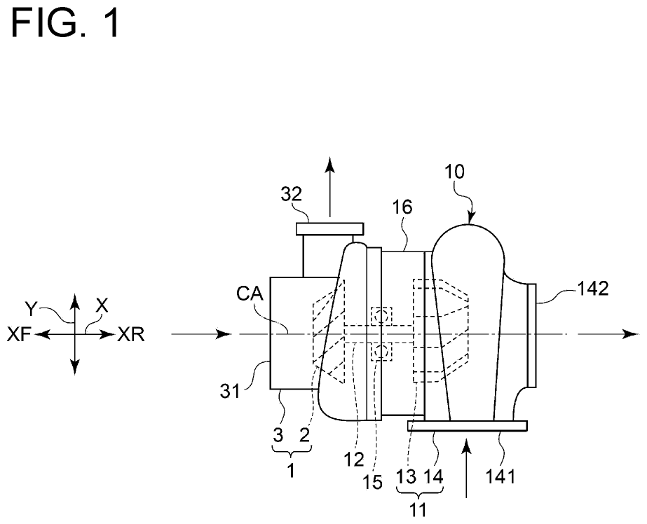

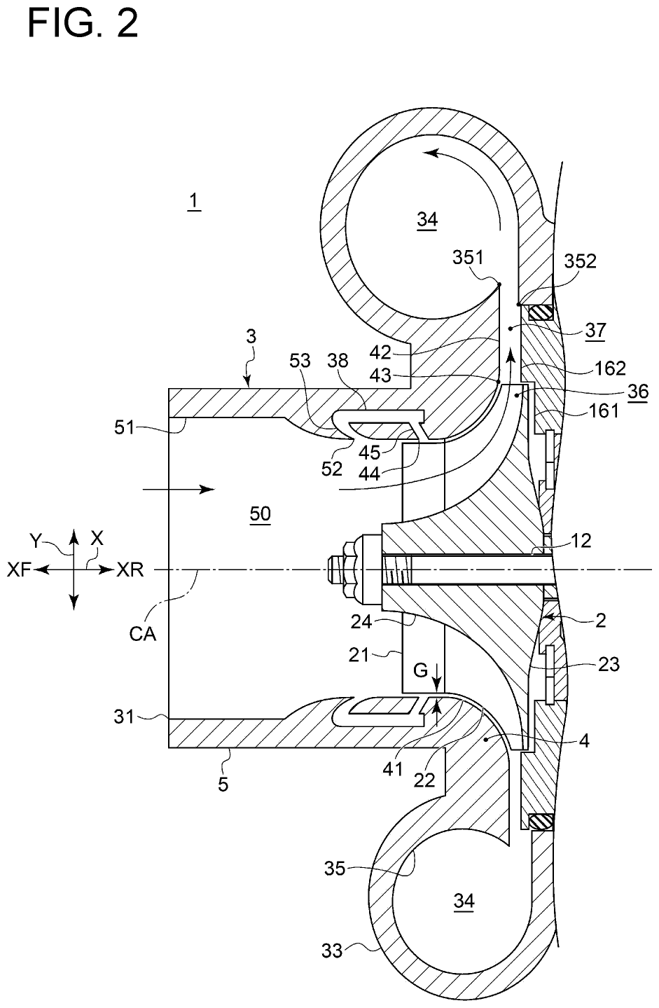

FIG. 1 is an explanatory view for describing the configuration of a turbocharger including a centrifugal compressor according to an embodiment. FIG. 2 is a schematic cross-sectional view schematically showing a compressor side of the turbocharger including the centrifugal compressor according to an embodiment, the schematic cross-sectional view including an axis of the centrifugal compressor.

As shown in FIG. 1, 2, a centrifugal compressor 1 according to some embodiments of the present disclosure includes an impeller 2 and a compressor housing 3 configured to rotatably house the impeller 2. As shown in FIG. 2, the compressor housing 3 at least includes a shroud portion 4 which has a shroud surface 41 facing a tip 22 of an impeller blade 21 of the impeller 2 with a predetermined gap G, and an intake air introduction portion 5 which has an introduction surface (inner wall surface) 51 defining an intake air introduction path 50 for guiding intake air (for example, a fluid such as air) introduced from an intake port 31 of the compressor housing 3 toward the impeller blade 21.

The centrifugal compressor 1 can be applied to, for example, a turbocharger 10 for an automobile, a ship, or power generation, or another industrial centrifugal compressor, blower, or the like. In the illustrated embodiment, the centrifugal compressor 1 is mounted on the turbocharger 10. As shown in FIG. 1, the turbocharger 10 includes the centrifugal compressor 1, a turbine 11, and a rotatable shaft 12. The turbine 11 includes a turbine rotor 13 mechanically coupled to the impeller 2 via the rotatable shaft 12 and a turbine housing 14 for rotatably housing the turbine rotor 13.

In the illustrated embodiment, as shown in FIG. 1, the turbocharger 10 further includes a bearing 15 for rotatably supporting the rotatable shaft 12 and a bearing housing 16 configured to house the bearing 15. The bearing housing 16 is disposed between the compressor housing 3 and the turbine housing 14, and is mechanically coupled to the compressor housing 3 or the turbine housing 14 by a fastening member such as a fastening bolt or the like.

Hereinafter, for example, as shown in FIG. 1, an extension direction of an axis of the centrifugal compressor 1, that is, an axis CA of the impeller 2 will be referred to as an axial direction X, and a direction orthogonal to the axis CA will be referred to as a radial direction Y. Of the axial direction X, an upstream side in a suction direction of the centrifugal compressor 1, that is, a side where the intake port 31 is located with respect to the impeller 2 (a left side in the drawing) will be referred to as a front side XF. Further, of the axial direction X, a downstream side in the suction direction of the centrifugal compressor 1, that is, a side where the impeller 2 is located with respect to the intake port 31 (a right side in the drawing) will be referred to as a rear side XR.

In the illustrated embodiment, as shown in FIG. 1, the compressor housing 3 is formed with the intake port 31 for introducing the fluid (such as air) from the outside of the compressor housing 3, and a discharge port 32 for discharging the fluid having passed through the impeller 2 to the outside of the compressor housing 3. The turbine housing 14 is formed with an exhaust gas introduction port 141 for introducing an exhaust gas into the turbine housing 14, and an exhaust gas discharge port 142 for discharging the exhaust gas having passed through the turbine rotor 13 to the outside of the turbine housing 14.

As shown in FIG. 1, the rotatable shaft 12 has a longitudinal direction along the axial direction X. The rotatable shaft 12 is mechanically coupled to the impeller 2 on one side (front side XF) in the longitudinal direction of the rotatable shaft 12, and is mechanically coupled to the turbine rotor 13 on another side (rear side XR) in the longitudinal direction of the rotatable shaft 12. Note that “along a certain direction” in the present disclosure includes not only the certain direction but also a direction inclined with respect to the certain direction.

The turbocharger 10 rotates the turbine rotor 13 by the exhaust gas introduced from an exhaust gas generation device (not shown) (for example, an internal combustion engine such as an engine) into the turbine housing 14 through the exhaust gas introduction port 141. Since the impeller 2 is mechanically coupled to the turbine rotor 13 via the rotatable shaft 12, the impeller 2 rotates in conjunction with the rotation of the turbine rotor 13. Rotating the impeller 2, the turbocharger 10 compresses the fluid introduced into the compressor housing 3 through the intake port 31 and sends the compressed fluid to a fluid supply destination (for example, the internal combustion engine such as the engine) through the discharge port 32.

(Impeller)

As shown in FIG. 2, the impeller 2 includes a hub 23 and a plurality of impeller blades 21 disposed on an outer surface 24 of the hub 23. Since the hub 23 is mechanically fixed to the one side (front side XF) of the rotatable shaft 12, the hub 23 or the plurality of impeller blades 21 are disposed to integrally be rotatable with the rotatable shaft 12 around the axis CA of the impeller 2. The impeller 2 is housed in the compressor housing 3 and is configured to guide the fluid introduced from the front side XF in the axial direction X to the outer side in the radial direction Y.

In the illustrated embodiment, the outer surface 24 of the hub 23 is formed into a concave curved shape in which a distance from the axis CA of the impeller 2 increases from the front side XF toward the rear side XR. The plurality of impeller blades 21 are spaced apart from each other in the circumferential direction around the axis CA. The gap G (clearance) is formed between the tip 22 of each of the plurality of impeller blades 21 and the shroud surface 41 curved convexly so as to face the tip 22. The shroud surface 41 is formed into a convex curved shape in which the distance from the axis CA of the impeller 2 increases from the front side XF toward the rear side XR.

(Compressor Housing)

In the illustrated embodiment, as shown in FIG. 2, the compressor housing 3 includes the shroud portion 4 having the shroud surface 41 described above, the intake air introduction portion 5 forming the intake air introduction path 50 described above, and a scroll portion 33 forming a spiral scroll passage 34 for guiding the fluid having passed through the impeller 2 to the outside of the compressor housing 3.

The intake air introduction path 50 and the scroll passage 34 are formed in the compressor housing 3. The intake air introduction portion 5 has the introduction surface 51 forming the intake air introduction path 50. The introduction surface 51 extends on the front side XF relative to the shroud surface 41 along the axial direction X, and the above-described intake port 31 is formed at a front side XF end. The scroll passage 34 is formed to be located on the outer side relative to the impeller 2 in the radial direction Y so as to surround the periphery of the impeller 2 housed in the compressor housing 3. The scroll portion 33 has an inner peripheral surface 35 forming the scroll passage 34.

Further, in the illustrated embodiment, as shown in FIG. 2, the compressor housing 3 is formed with an impeller chamber 36 which is a space for rotatably housing the impeller 2 and a diffuser passage 37 of the centrifugal compressor 1 for guiding the fluid from the impeller 2 to the scroll passage 34, by being combined with another member (the bearing housing 16 in the illustrated example). In some other embodiments, the compressor housing 3 may internally form the impeller chamber 36 or the diffuser passage 37.

The above-described shroud portion 4 is disposed between the intake air introduction portion 5 and the scroll portion 33. The shroud surface 41 of the shroud portion 4 forms a front side XF section of the impeller chamber 36. The bearing housing 16 has an impeller chamber forming surface 161 disposed to face the shroud surface 41 on the rear side XR relative to the shroud surface 41, and the impeller chamber forming surface 161 forms a rear side XR section of the impeller chamber 36.

The shroud portion 4 has a shroud-side passage surface 42 forming the front side XF section of the diffuser passage 37, and the shroud-side passage surface 42 connects a rear-side end 43 of the shroud surface 41 and one end 351 of the inner peripheral surface 35. The bearing housing 16 has a hub-side passage surface 162 disposed to face the shroud-side passage surface 42 on the rear side XR relative to the shroud-side passage surface 42. The hub-side passage surface 162 is disposed on the outer side relative to the impeller chamber forming surface 161 in the radial direction Y, and connects the impeller chamber forming surface 161 and another end 352 of the inner peripheral surface 35. In a cross section along the axis CA as shown in FIG. 2, the shroud-side passage surface 42 and the hub-side passage surface 162 extend along a direction intersecting (in the illustrated example, is orthogonal to) the axis CA.

An outlet of the intake air introduction path 50 communicates with an inlet of the impeller chamber 36, and an outlet of the impeller chamber 36 communicates with an inlet of the diffuser passage 37. The fluid introduced into the compressor housing 3 through the intake port 31 flows through the intake air introduction path 50 toward the rear side XR, and then is sent to the impeller 2. The fluid sent to the impeller 2 flows through the diffuser passage 37 and the scroll passage 34 in this order, and then is discharged to the outside of the compressor housing 3 from the discharge port 32 (see FIG. 1).

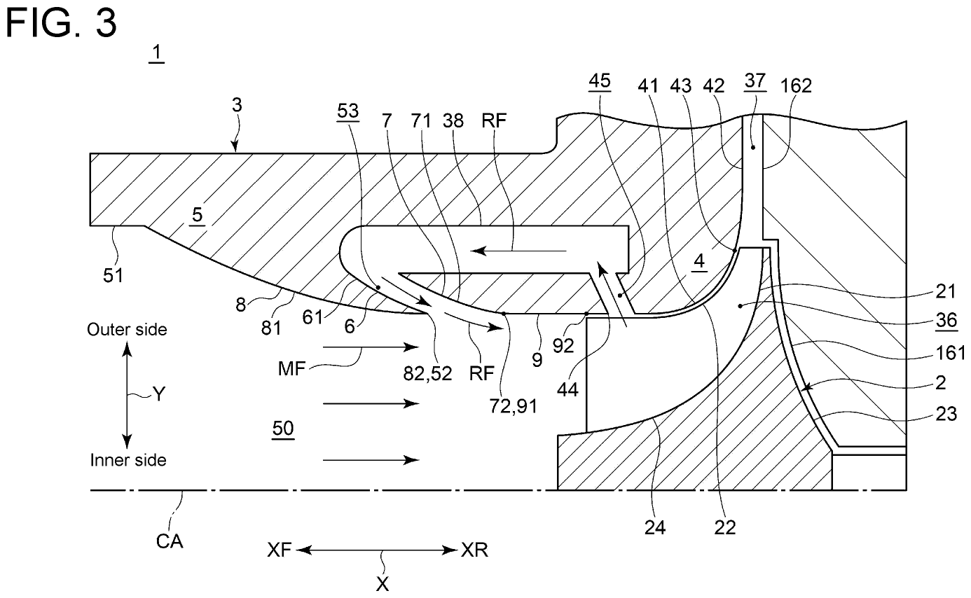

FIG. 3 is an explanatory view for describing the intake air introduction portion according to an embodiment. Each of FIG. 3 and FIGS. 4 to 13 described later schematically shows a cross section along the axis CA of the impeller 2.

As shown in FIG. 2, 3, the compressor housing 3 internally forms an inlet passage 45 with an inflow port 44 formed in the shroud surface 41, an outlet passage 53 with an outflow port 52 formed in the introduction surface 51, and a recirculation passage 38 connecting the inlet passage 45 and the outlet passage 53. The inlet passage 45 communicates with the impeller chamber 36 through the inflow port 44, and the outlet passage 53 communicates with the intake air introduction path 50 through the outflow port 52. Thus, the recirculation passage 38 communicates with the impeller chamber 36 through the inlet passage 45 and communicates with the intake air introduction path 50 through the outlet passage 53. If the impeller 2 of the centrifugal compressor 1 is rotary driven, a recirculation flow RF is generated due to a pressure difference between the inflow port 44 and the outflow port 52. The recirculation flow RF is introduced from the impeller chamber 36 to the inlet passage 45 through the inflow port 44, flows through the inlet passage 45, the recirculation passage 38, and the outlet passage 53 in this order, and then flows out to the intake air introduction path 50 through the outflow port 52.

At a low flow rate when the intake flow rate of the centrifugal compressor 1 (the flow rate of a main flow MF flowing into the intake air introduction path 50 through the intake port 31 and flowing to the impeller 2) is low, an instability phenomenon called surging may occur in which the fluid vibrates violently in a fluid flow direction. If surging occurs, a backflow, which flows in a reverse direction from the main flow MF, that is, toward the front side XF in the axial direction X, occurs in the vicinity of the shroud surface 41 of the impeller chamber 36, which may lead to a decrease in efficiency of the centrifugal compressor 1. The compressor housing 3 of the centrifugal compressor 1 is formed with the inlet passage 45, the recirculation passage 38, and the outlet passage 53. In this case, a part of the fluid in the impeller chamber 36 returns to the impeller chamber 36 again as the recirculation flow RF through the recirculation passage 38, the intake air introduction path 50, or the like, making it possible to increase the flow rate of the fluid sent to the impeller 2. Thus, it is possible to suppress the occurrence of surging. Since the occurrence of surging at the low flow rate is suppressed, the centrifugal compressor 1 can achieve a high pressure ratio in a wide operating range from the low flow rate to the high flow rate.

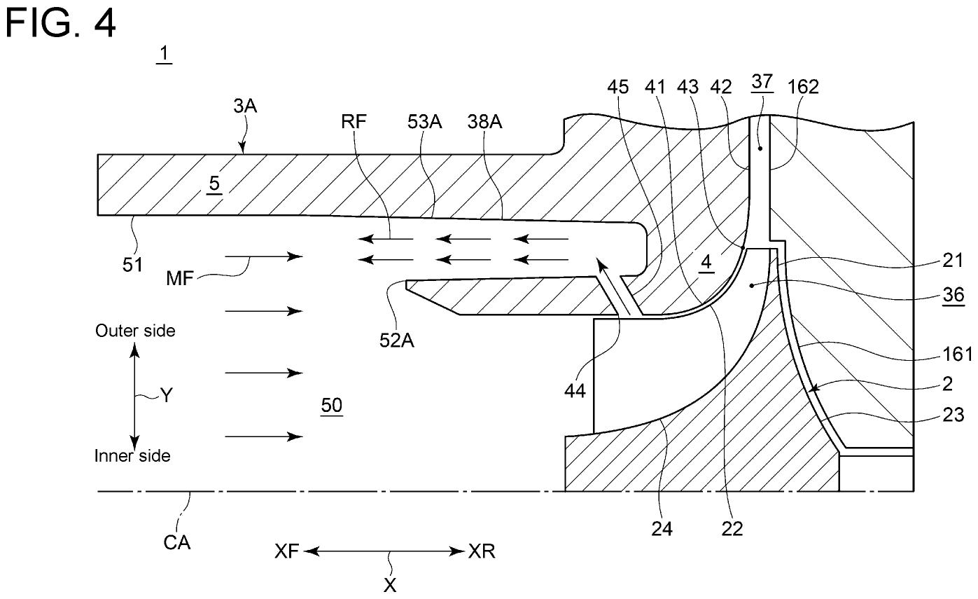

FIG. 4 is an explanatory view for describing the intake air introduction portion according to a comparative example. A compressor housing 3A according to the comparative example internally forms the inlet passage 45 with the inflow port 44 formed in the shroud surface 41 described above, a recirculation passage 38A communicating with the inlet passage 45 and extending toward the front side XF along the axial direction X, and an outlet passage 53A communicating with the front side XF of the recirculation passage 38A, the outlet passage 53A including an outflow port 52A opening toward the front side XF. In this case, the recirculation flow RF flowing into the recirculation passage 38A from the impeller chamber 36 through the inlet passage 45 flows through the recirculation passage 38A toward the front side XF, and then flows out to the intake air introduction path 50 through the outflow port 52A while maintaining the flow direction. The flow direction of the recirculation flow RF flowing out to the intake air introduction path 50 is reverse from the flow direction of the main flow MF flowing through the intake air introduction path 50 toward the rear side XR. Thus, the recirculation flow RF and the main flow MF interfere with each other, which may increase a pressure loss of the main flow MF or the recirculation flow RF, and decrease the efficiency of the centrifugal compressor 1.

(Intake Air Introduction Portion)

As shown in FIG. 3, the compressor housing 3 of the centrifugal compressor 1 according to some embodiments includes the shroud portion 4 having the shroud surface 41 described above, and the intake air introduction portion 5 having the introduction surface 51 described above. The compressor housing 3 internally forms the inlet passage 45, the outlet passage 53, and the recirculation passage 38 described above. In a cross-sectional view along the axis CA of the impeller 2, the above-described intake air introduction portion 5 has a front-side surface 6 defining the front side XF in the outlet passage 53, a rear-side surface 7defining the rear side XR in the outlet passage 53, and a front-side introduction surface 8 formed on the front side XF relative to the outflow port 52 on the introduction surface 51 described above, as shown in FIG. 3. Each of the front-side surface 6, the rear-side surface 7, and the front-side introduction surface 8 is inclined to the rear side XR from the outer side toward the inner side in the radial direction Y In other words, each of the front-side surface 6, the rear-side surface 7, and the front-side introduction surface 8 is disposed such that the distance from the axis CA decreases toward the rear side XR. The rear-side surface 7 includes a convex curved portion 71 formed into a convex curved shape at least in part. The front-side introduction surface 8 includes an introduction surface-side convex curved portion 81 formed into a convex curved shape at least in part.

In the illustrated embodiment, as shown in FIG. 2, the recirculation passage 38 is formed into an annular shape. The recirculation passage 38 may be formed into a shape other than the annular shape. In the illustrated embodiment, as shown in FIG. 3, the intake air introduction portion 5 further has a rear-side introduction surface 9 formed on the rear side XR relative to the outflow port 52 on the introduction surface 51. The rear-side introduction surface 9 is located on the rear side XR relative to the rear-side surface 7, and has a front-side end 91 smoothly connected to a rear-side end 72 of the rear-side surface 7 without any step. Further, the rear-side introduction surface 9 is located on the front side XF relative to the shroud surface 41, and has a rear-side end 92 smoothly connected to a front-side end 46 of the shroud surface 41 without any step.

With the above configuration, since each of the front-side surface 6 and the rear-side surface 7 defining the outlet passage 53 is inclined to the rear side XR from the outer side toward the inner side in the radial direction Y, the outlet passage 53 can turn the recirculation flow RF passing through the outlet passage 53 such that a velocity component toward the rear side XR in the axial direction X is increased and a velocity component toward the inner side in the radial direction Y is decreased. The recirculation flow RF flows toward the front side XF in the axial direction X when passing through the recirculation passage 38. The flow direction of the recirculation flow RF is changed by the outlet passage 53 to a direction toward the inner side in the radial direction Y and the rear side XR.

Further, since the rear-side surface 7 includes the convex curved portion 71 formed into the convex curved shape at least in part, it is possible to produce an effect of drawing in the recirculation flow RF by the Coanda effect. Thus, it is possible to suppress that the recirculation flow RF flowing out to the intake air introduction path 50 separates from the rear-side surface 7, making it possible to effectively turn the recirculation flow RF in the outlet passage 53.

Since the velocity component of the recirculation flow RF flowing out to the intake air introduction path 50 toward the rear side XR in the axial direction is increased by turning the recirculation flow RF as described above, it is possible to suppress the occurrence of the backflow in the vicinity of the shroud surface 41. Further, since the velocity component of the recirculation flow RF flowing out to the intake air introduction path 50 toward the inner side in the radial direction Y is decreased by turning the recirculation flow RF as described above, it is possible to suppress the interference between the main flow MF flowing through the intake air introduction path 50 toward the rear side XR and the recirculation flow RF flowing out to the intake air introduction path 50, and it is possible to reduce the pressure loss of the main flow MF or the recirculation flow RF. Thus, with the above configuration, it is possible to suppress the occurrence of the pressure loss of the fluid in the compressor housing 3 and improve the efficiency of the centrifugal compressor 1.

Further, with the above configuration, the front-side introduction surface 8 is inclined to the rear side XR from the outer side toward the inner side in the radial direction Y, and includes the introduction surface-side convex curved portion 81 formed into the convex curved shape at least in part. In this case, it is possible to suppress the pressure loss due to collision of the main flow MF flowing through the intake air introduction path 50 to the rear side XR with the front-side introduction surface 8.

In some embodiments, as show in FIG. 3, the above-described front-side surface 6 includes a concave curved portion 61 formed into a concave curved shape at least in part. In the illustrated embodiment, the concave curved portion 61 is formed at a position including the rear-side end (the front-side edge of the outflow port 52) on the front-side surface 6, and the introduction surface-side convex curved portion 81 is formed at a position including the rear-side end 82 (the front-side edge of the outflow port 52) on the front-side introduction surface 8. The rear-side end of the concave curved portion 61 continues to the rear-side end of the introduction surface-side convex curved portion 81.

With the above configuration, since the recirculation flow RF passing through the outlet passage 53 is guided by the concave curved portion 61, it is possible to effectively turn the recirculation flow RF in the outlet passage 53. Thus, an inclination angle of the flow direction of the recirculation flow RF with respect to the flow direction of the main flow MF flowing toward the rear side XR along the axial direction X can become gentle, in the cross section along the axis CA. Since the inclination angle becomes gentle, it is possible to suppress the interference between the main flow MF and the recirculation flow RF. Thus, it is possible to effectively suppress the occurrence of the backflow in the vicinity of the shroud surface 41, and it is possible to effectively suppress the pressure loss of the main flow MF or the recirculation flow RF due to the interference between the main flow MF and the recirculation flow RF.

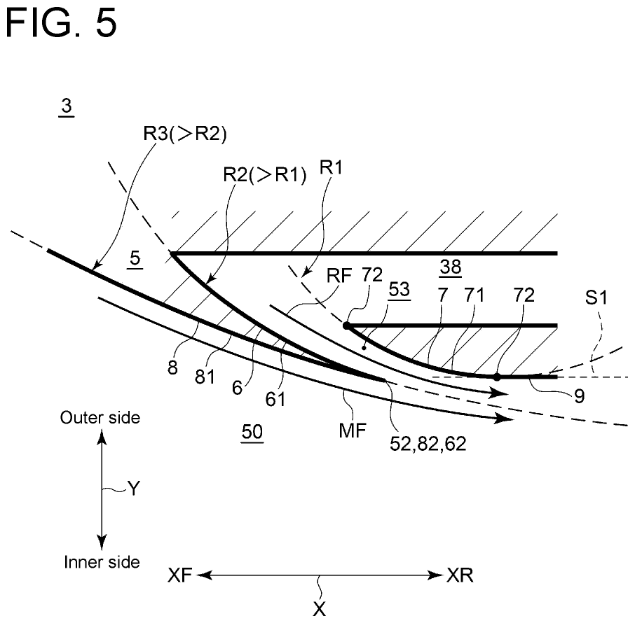

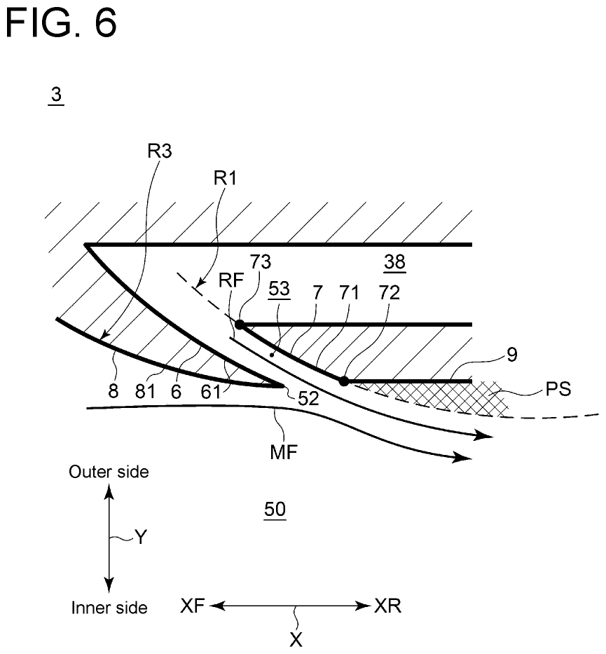

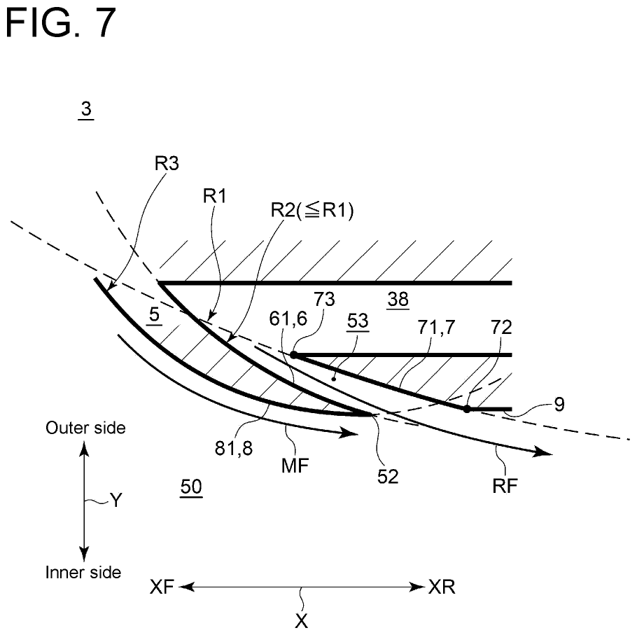

FIG. 5 is an explanatory view for describing the vicinity of the outlet passage of the intake air introduction portion according to an embodiment. FIGS. 6 and 7 are each an explanatory view for describing the vicinity of the outlet passage of the intake air introduction portion according to a comparative example.

In some embodiments, as shown in FIG. 5, the convex curved portion 71 of the rear-side surface 7 described above is formed at the position including at least the rear-side end 72 of the rear-side surface 7. In the illustrated embodiment, the convex curved portion 71 of the rear-side surface 7 described above is formed over from a front-side end 73 to the rear-side end 72 of the rear-side surface 7. A tangent direction of the convex curved portion 71 passing through the rear-side end 72 coincides with an extension direction of the rear-side introduction surface 9 formed on the rear side XR relative to the outflow port 52 on the introduction surface 51. In FIG. 5, Si is a tangent line of the convex curved portion 71 passing through the rear-side end 72. The rear-side introduction surface 9 extends along the extension direction of the tangent line S1, that is, the axial direction X. In this case, the convex curved portion 71 of the rear-side surface 7 and the rear-side introduction surface 9 can smoothly be connected without any step. Thus, the recirculation flow RF flowing through the outlet passage 53 along the convex curved portion 71 can be caused to directly flow along the rear-side introduction surface 9, making it possible to effectively turn the recirculation flow RF in the outlet passage 53. That is, the inclination angle of the flow direction of the recirculation flow RF with respect to the flow direction of the main flow MF flowing toward the rear side XR along the axial direction X can become gentle, in the cross section along the axis CA. Further, since the recirculation flow RF is caused to flow along the rear-side introduction surface 9, it is possible to effectively suppress the occurrence of the backflow in the vicinity of the shroud surface 41.

If, as shown in FIG. 6, the tangent direction of the convex curved portion 71 passing through the rear-side end 72 intersects the extension direction of the rear-side introduction surface 9, the recirculation flow RF flowing through the outlet passage 53 along the convex curved portion 71 separates from the rear-side introduction surface 9. Consequently, the recirculation flow RF flowing out to the intake air introduction path 50 flows on the inner side in the radial direction Y relative to a space (separation space) PS facing the rear-side introduction surface 9 in the intake air introduction path 50, increasing the degree of the interference between the recirculation flow RF and the main flow MF, and increasing the possibility of the increase in pressure loss of the main flow MF or the recirculation flow RF due to the interference between the main flow MF and the recirculation flow RF. In addition, the possibility of the backflow occurring in the vicinity of the separation space PS or the shroud surface 41 described above increases.

For example, as shown in FIG. 5, R1 is a radius of curvature of the convex curved portion 71 on the rear-side surface 7, R2 is a radius of curvature of the concave curved portion 61 on the front-side surface 6, and R3 is a radius of curvature of the introduction surface-side convex curved portion 81 on the front-side introduction surface 8.

In some embodiments, as shown in FIG. 5, the above-described compressor housing 3 satisfies a relationship of R3>R1. With the above configuration, since the radius of curvature R1 of the convex curved portion 71 on the rear-side surface 7 is smaller than the radius of curvature R3 of the introduction surface-side convex curved portion 81, it is possible to effectively turn the recirculation flow RF in the outlet passage 53. That is, the inclination angle of the flow direction of the recirculation flow RF with respect to the flow direction of the main flow MF flowing toward the rear side XR along the axial direction X can become gentle, in the cross section along the axis CA. Thus, it is possible to effectively suppress the occurrence of the backflow in the vicinity of the shroud surface 41, and it is possible to effectively suppress the pressure loss of the main flow MF or the recirculation flow RF due to the interference between the main flow MF and the recirculation flow RF.

If, as shown in FIG. 6, the radius of curvature R1 of the convex curved portion 71 on the rear-side surface 7 is not smaller than the radius of curvature R3 of the introduction surface-side convex curved portion 81, the degree to which the recirculation flow RF is turned in the outlet passage 53 is low. That is, the inclination angle of the flow direction of the recirculation flow RF with respect to the flow direction of the main flow MF flowing toward the rear side XR along the axial direction X becomes steep, in the cross section along the axis CA. In this case, the degree of the interference between the recirculation flow RF and the main flow MF increases, and the possibility of the increase in pressure loss of the main flow MF or the recirculation flow RF due to the interference between the main flow MF and the recirculation flow RF increases. In addition, the possibility of the backflow occurring in the vicinity of the separation space PS or the shroud surface 41 described above increases.

In some embodiments, as shown in FIG. 5, the above-described compressor housing 3 satisfies a relationship of R2>R1. If, as shown in FIG. 7, the above-described compressor housing 3 satisfies a relationship of R2<R1, a passage area of the outlet passage 53 is rapidly reduced at an inlet side located opposite to the outflow port 52, which may increase the pressure loss of the recirculation flow RF when passing through the outlet passage 53. With the above configuration, since the radius of curvature R2 of the concave curved portion 61 on the front-side surface 6 is larger than the radius of curvature R1 of the convex curved portion 71 on the rear-side surface 7, it is possible to alleviate the rapid reduction in passage area of the outlet passage 53 at the inlet side, making it possible to reduce the pressure loss of the recirculation flow RF passing through the outlet passage 53.

In some embodiments, as shown in FIG. 5, the above-described compressor housing 3 satisfies a relationship of R3>R2>R1. With the above configuration, since the radius of curvature R3 of the introduction surface-side convex curved portion 81 is larger than the radius of curvature R1 of the convex curved portion 71 on the rear-side surface 7, it is possible to suppress the interference caused when the main flow MF flowing through the intake air introduction path 50 joins the recirculation flow RF flowing out from the outlet passage 53 to the intake air introduction path 50. Thus, it is possible to reduce the pressure loss of the main flow MF or the recirculation flow RF. Further, since the radius of curvature R2 of the concave curved portion 61 on the front-side surface 6 is larger than the radius of curvature R1 of the convex curved portion 71 on the rear-side surface 7, it is possible to alleviate the rapid reduction in passage area of the outlet passage 53 at the inlet side, making it possible to reduce the pressure loss of the recirculation flow RF passing through the outlet passage 53. Thus, with the above configuration, since the main flow MF or the recirculation flow RF with the small pressure loss in the intake air introduction path 50 or the outlet passage 53 can be sent to the impeller 2, it is possible to effectively improve the efficiency of the centrifugal compressor 1.

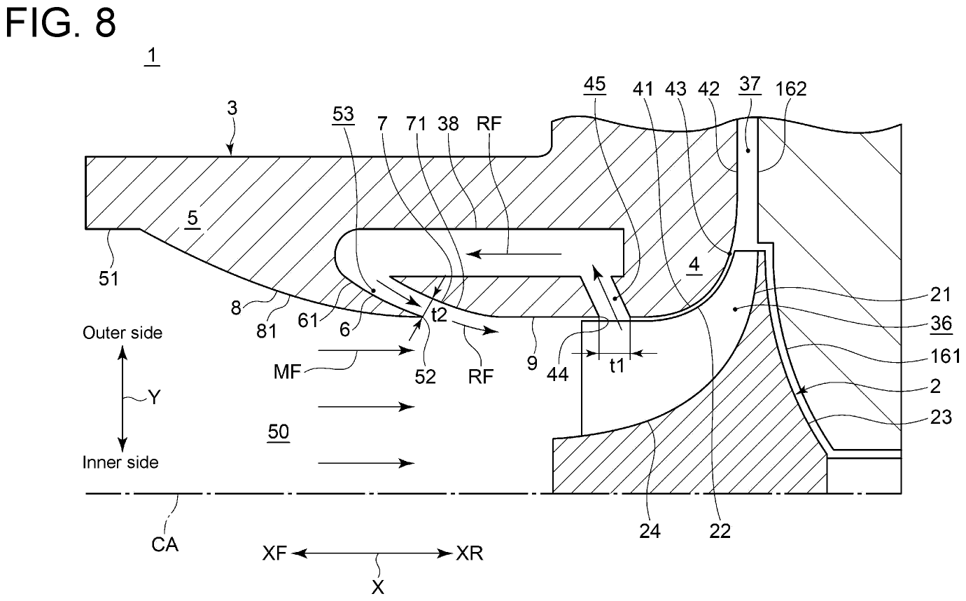

FIG. 8 is an explanatory view for describing the intake air introduction portion according to an embodiment.

In some embodiments, as shown in FIG. 8, in the cross-sectional view along the axis CA of the impeller 2, a relationship of t1>t2 is satisfied, where t1 is a passage width of the inlet passage 45 in the inflow port 44 described above, and t2 is a passage width of the outlet passage 53 in the outflow port 52 described above. In this case, since the passage width t2 of the outlet passage 53 in the outflow port 52 is larger than the passage width t1 of the inlet passage 45 in the inflow port 44, it is possible to increase the flow velocity of the recirculation flow RF passing through the outflow port 52 of the outlet passage 53. Since the flow velocity of the recirculation flow RF introduced to the intake air introduction path 50 is increased, it is possible to increase the effect of suppressing the backflow in the vicinity of the shroud surface 41 by the recirculation flow RF.

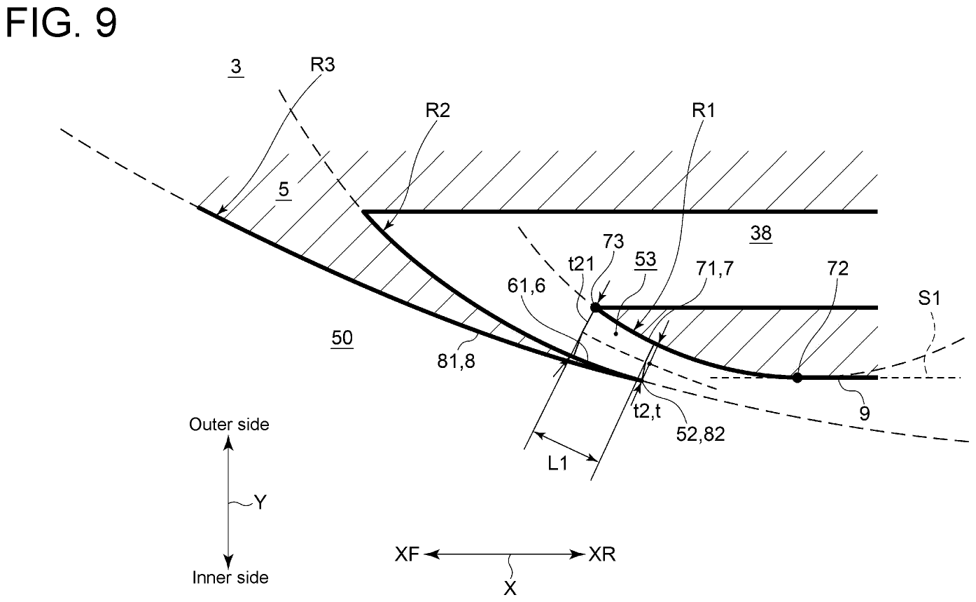

FIG. 9 is an explanatory view for describing the vicinity of the outlet passage of the intake air introduction portion according to an embodiment.

In some embodiments, a passage width t of the above-described outlet passage 53 is formed to be the same throughout the outlet passage 53, that is, over from the inlet side to the outflow port 52 of the outlet passage 53 as shown in FIG. 8, or is formed to gradually decrease toward the outflow port 52 as shown in FIG. 9. In the embodiment shown in FIG. 9, a passage width t21 at a connection position of the outlet passage 53 with the recirculation passage 38, which is formed at a position including the inlet side of the outlet passage 53, that is, the front-side end 73 of the rear-side surface 7, is the maximum passage width t. Further, the passage width t2 at the outlet side of the outlet passage 53, that is, the outflow port 52 is the minimum passage width t.

With the above configuration, since the passage width t of the outlet passage 53 is formed to be the same throughout the outlet passage 53 or is formed to gradually decrease toward the outflow port 52, it is possible to increase the flow velocity of the recirculation flow RF passing through the outflow port 52 of the outlet passage 53. Since the flow velocity of the recirculation flow RF introduced to the intake air introduction path 50 is increased, it is possible to increase the effect of suppressing the backflow in the vicinity of the shroud surface 41 by the recirculation flow RF. Further, since the passage width t of the outlet passage 53 is formed to be the same throughout the outlet passage 53 or is formed to gradually decrease toward the outflow port 52, it is possible to suppress the rapid reduction in passage area of the outlet passage 53 at the inlet side. Thus, it is possible to suppress the pressure loss of the recirculation flow RF passing through the outlet passage 53.

In some embodiments, as shown in FIG. 9, a condition of L1≥0 is satisfied, where L1 is a passage length of the outlet passage 53. The passage length L1 of the outlet passage 53 is a length from the connection position of the outlet passage 53 with the recirculation passage 38 described above to the outflow port 52. In this case, since the length of the outlet passage 53 can sufficiently be large, it is possible to lengthen the curved portion (for example, the convex curved portion 71 of the rear-side surface 7 or the concave curved portion 61 of the front-side surface 6) formed on a wall surface defining the outlet passage 53. Since the above-described curved portion is lengthened, it is possible to promote the turning of the recirculation flow RF. Further, it is possible to suppress the rapid reduction in passage are of the outlet passage 53, and it is possible to suppress the pressure loss of the recirculation flow RF passing through the outlet passage 53.

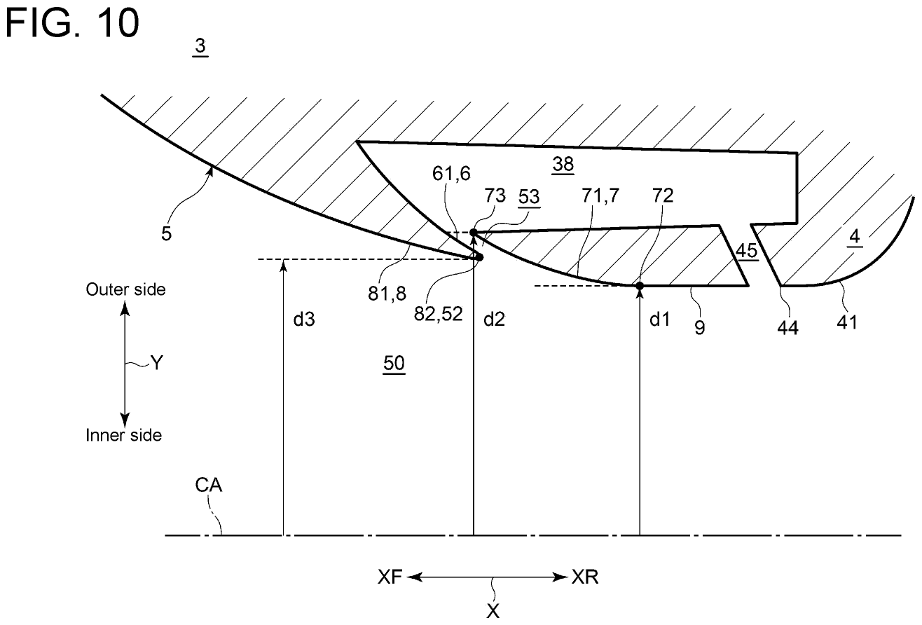

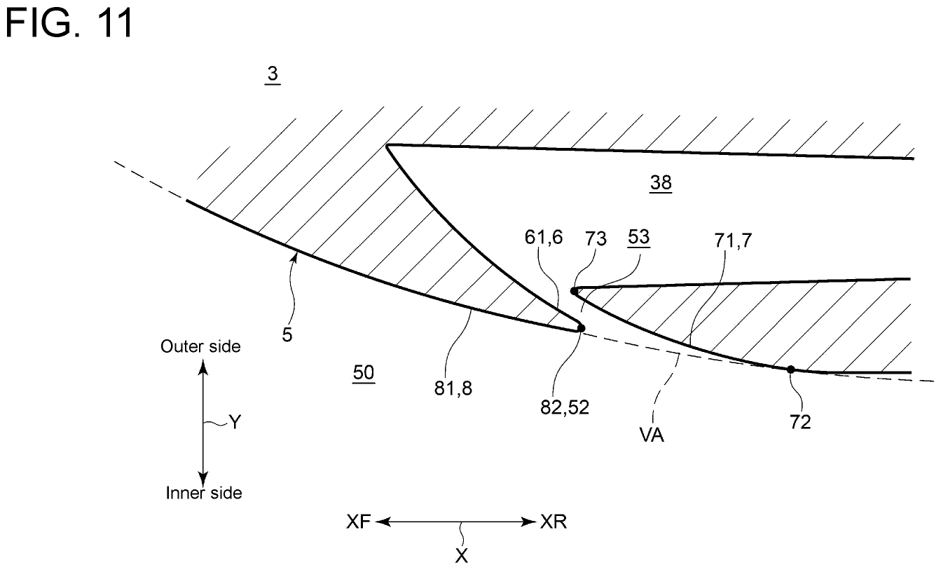

FIG. 10 is an explanatory view for describing the vicinity of the outlet passage of the intake air introduction portion according to an embodiment. FIG. 11 is an explanatory view for describing the rear-side surface shown in FIG. 10.

In some embodiments, as shown in FIGS. 9 to 11, the rear-side end 82 of the front-side introduction surface 8 described above is located on the front side XF relative to the front-side end 73 of the rear-side surface 7. In this case, since the length L1 of the outlet passage 53 can sufficiently be large, it is possible to lengthen the curved portion (for example, the convex curved portion 71 of the rear-side surface 7 or the concave curved portion 61 of the front-side surface 6) formed on the wall surface defining the outlet passage 53. Since the above-described curved portion is lengthened, it is possible to promote the turning of the recirculation flow RF.

As shown in FIG. 10, d1 is a distance between the rear-side end 72 of the rear-side surface 7 and the axis CA of the impeller 2 described above, d2 is a distance between the front-side end 73 of the rear-side surface 7 and the axis CA of the impeller 2 described above, and d3 is a distance between the rear-side end 82 of the front-side introduction surface 8 and the axis CA of the impeller 2.

In some embodiments, as shown in FIG. 10, the above-described compressor housing 3 satisfies a relationship of d3>d1. With the above configuration, the distance d3 between the axis CA and the rear-side end 82 of the front-side introduction surface 8 is greater than the distance d1 between the axis CA and the rear-side end 72 of the rear-side surface 7. In this case, the recirculation flow RF is returned to a section of the intake air introduction path 50 where the passage area is reduced (area reduced section), promoting mixture of the recirculation flow RF and the main flow MF, and making it possible to achieve uniformity in velocity distribution of the fluid introduced to the impeller 2. Thus, it is possible to suppress the occurrence of surging or the occurrence of the backflow in the vicinity of the shroud surface 41.

In some embodiments, as shown in FIG. 10, the above-described compressor housing 3 satisfies a relationship of d3≤d2. With the above configuration, the distance d2 between the axis CA and the front-side end 73 of the rear-side surface 7 is the same as the distance d3 between the axis CA and the rear-side end 82 of the front-side introduction surface 8, or greater than the above-described distance d3. In this case, it is possible to prevent the main flow MF flowing through the intake air introduction path 50 toward the rear side XR and the recirculation flow RF flowing out to the intake air introduction path 50 from facing each other. Thus, it is possible to suppress the interference between the main flow MF and the recirculation flow RF, and it is possible to reduce the pressure loss of the main flow MF or the recirculation flow RF.

In some embodiments, as shown in FIG. 10, the above-described compressor housing 3 satisfies a relationship of d1<d3≤d2. With the above configuration, the distance d2 is the same as the distance d3, or greater than the distance d3. In this case, it is possible to prevent the main flow MF flowing through the intake air introduction path 50 toward the rear side XR and the recirculation flow RF flowing out to the intake air introduction path 50 from facing each other. Thus, it is possible to suppress the interference between the main flow MF and the recirculation flow RF, and it is possible to reduce the pressure loss of the main flow MF or the recirculation flow RF. Further, the distance d3 is greater than the distance d1. In this case, the recirculation flow RF is returned to the section of the intake air introduction path 50 where the passage area is reduced (area reduced section), promoting mixture of the recirculation flow RF and the main flow MF, and making it possible to achieve uniformity in velocity distribution of the fluid introduced to the impeller 2. Thus, it is possible to suppress the occurrence of surging or the occurrence of the backflow in the vicinity of the shroud surface 41.

Further, with the above configuration, the distance d2 is greater than the distance d1. In this case, it is possible to reduce a swirling velocity component of the recirculation flow RF when passing through the outlet passage 53. Thus, it is possible to suppress the interference between the main flow MF flowing through the intake air introduction path 50 toward the rear side XR and the recirculation flow RF flowing out to the intake air introduction path 50, and it is possible to reduce the pressure loss of the main flow MF or the recirculation flow RF.

In some embodiments, as shown in FIG. 11, the introduction surface-side convex curved portion 81 of the front-side introduction surface 8 described above is formed at a position including at least the rear-side end 82 of the front-side introduction surface 8, and a virtual arc VA including the introduction surface-side convex curved portion 81 is configured to touch the rear-side end 72 of the rear-side surface 7.

With the above configuration, since the virtual arc VA including the introduction surface-side convex curved portion 81 is configured to touch the rear-side end 72 of the rear-side surface 7, it is possible to cause the main flow MF flowing along the introduction surface-side convex curved portion 81 to flow along the rear-side introduction surface 9 connected to the rear-side end 72 of the rear-side surface 7. Further, it is possible to cause the recirculation flow RF passing through the outflow port 52 along the rear-side surface 7 to flow along the rear-side introduction surface 9. Thus, the inclination angle of the flow direction of the recirculation flow RF with respect to the flow direction of the main flow MF can become gentle. Since the inclination angle becomes gentle, it is possible to suppress the interference between the main flow MF and the recirculation flow RF. Since the interference between the main flow MF and the recirculation flow RF is suppressed, it is possible to effectively suppress the pressure loss of the main flow MF or the recirculation flow RF.

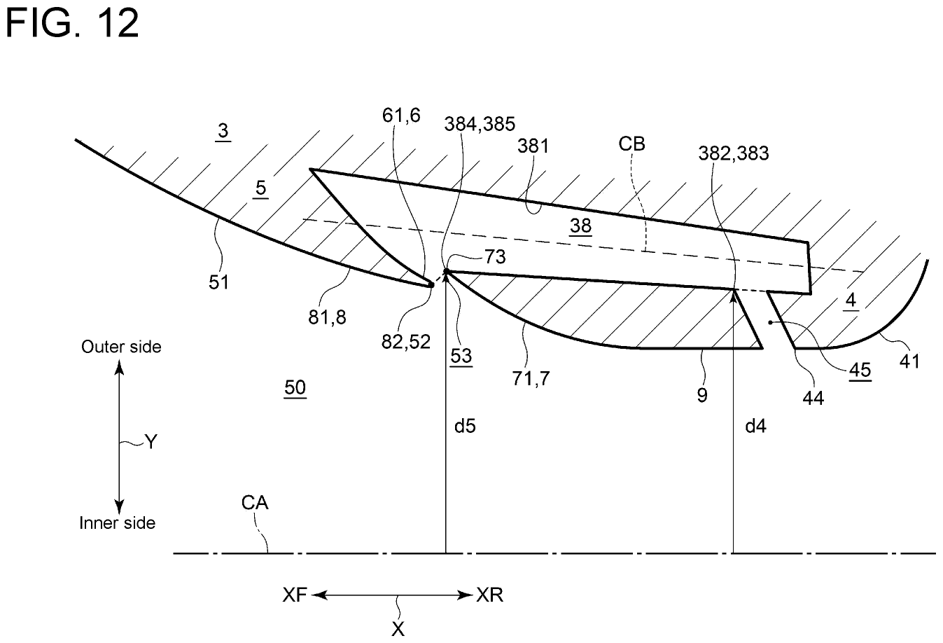

FIG. 12 is an explanatory view for describing the intake air introduction portion according to an embodiment.

In some embodiments, as shown in FIG. 12, an inner peripheral surface 381 forming the above-described recirculation passage 38 extends obliquely to the axial direction of the impeller 2 such that a distance from the axis CA of the impeller 2 increases from a connection position 382 with the inlet passage 45 toward a connection position 384 with the outlet passage 53. In the illustrated embodiment, d4 is a distance between the axis CA of the impeller 2 and a front-side end 383 at the connection position 382 with the inlet passage 45 of the inner peripheral surface 381, and d5 is a distance between the axis CA of the impeller 2 and a rear-side end 385 at the connection position 384 with the outlet passage 53 of the inner peripheral surface 381. The above-described distance d5 is greater than the above-described distance d4. Further, the recirculation passage 38 is formed such that a distance between an axis CB of the recirculation passage 38 and the axis CA of the impeller 2 gradually increases toward the front side XF.

With the above configuration, since the inner peripheral surface 381 forming the recirculation passage 38 is configured such that the distance from the axis CA of the impeller 2 increases from the connection position 382 with the inlet passage 45 toward the connection position 384 with the outlet passage 53, it is possible to reduce the swirling velocity component of the recirculation flow RF flowing through the recirculation passage 38. Since the swirling velocity component of the recirculation flow RF is reduced, it is possible to suppress the interference between the main flow MF flowing through the intake air introduction path 50 toward the rear side XR and the recirculation flow RF flowing out to the intake air introduction path 50, and it is possible to reduce the pressure loss of the main flow MF or the recirculation flow RF.

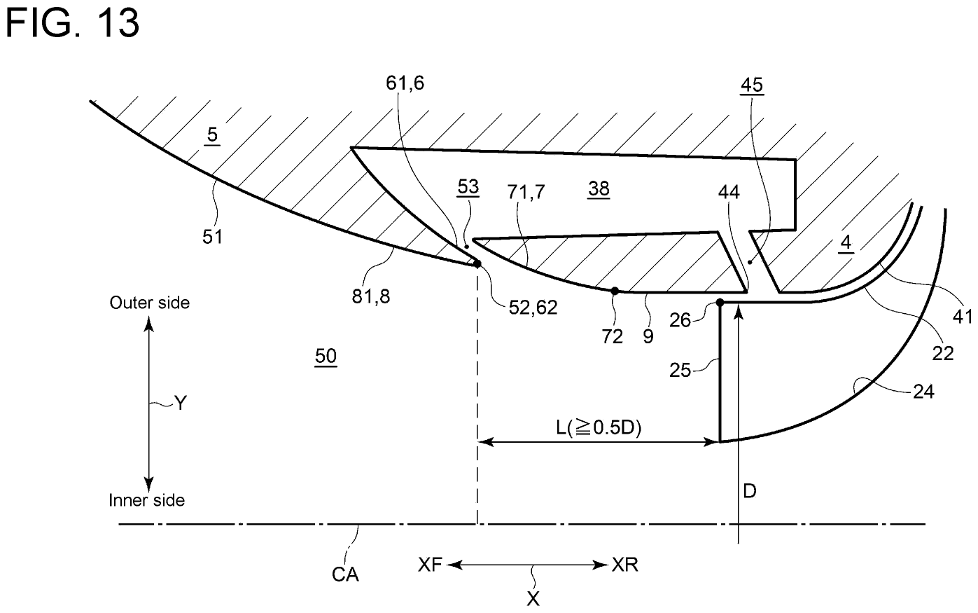

FIG. 13 is an explanatory view for describing the intake air introduction portion according to an embodiment.

In some embodiments, as shown in FIG. 13, a relationship of L≤0.5×D is satisfied, where L is a distance parallel to the axial direction of the impeller 2 between the impeller blade 21 and the rear-side end 82 of the front-side introduction surface 8 described above, and D is a diameter of a leading edge 25 of the impeller blade 21. In the illustrated embodiment, the above-described L is the minimum length in the axial direction X between the rear-side end 82 of the front-side introduction surface 8 and the leading edge 25 of the impeller blade 21, and the above-described D is the maximum diameter of the shroud-side end 26 at the leading edge 25 of the impeller blade 21. With the above configuration, the relationship of L≤0.5×D is satisfied. In this case, since the outflow port 52 of the outlet passage 53 is disposed near the impeller blade 21, it is possible to return the recirculation flow RF near the leading edge 25 of the impeller blade 21. Thus, it is possible to increase the effect of suppressing the backflow in the vicinity of the shroud surface 41 by the recirculation flow RF.

As shown in FIG. 2, the centrifugal compressor 1 according to some embodiments includes the above-described compressor housing 3. In this case, with the compressor housing 3, since it is possible to suppress the occurrence of the pressure loss of the fluid in the compressor housing 3, it is possible to improve the efficiency of the centrifugal compressor 1.

The present disclosure is not limited to the above-described embodiments, and also includes an embodiment obtained by modifying the above-described embodiments and an embodiment obtained by combining these embodiments as appropriate.

The contents described in some embodiments described above would be understood as follows, for instance.

1) A compressor housing (3) according to at least one embodiment of the present disclosure is a compressor housing (3) for rotatably housing an impeller (2) of a centrifugal compressor (1), including: a shroud portion (4) which has a shroud surface (41) facing a tip (23) of an impeller blade (21) of the impeller (2) with a predetermined gap; and an intake air introduction portion (5) which has an introduction surface (51) formed on a front side of the shroud surface (41), the introduction surface (51) defining an intake air introduction path (50) for guiding intake air introduced from an intake port (31) of the compressor housing (3) toward the impeller blade (21). The compressor housing (3) internally forms: an inlet passage (45) with an inflow port (44) formed in the shroud surface (41); an outlet passage (53) with an outflow port (52) formed in the introduction surface (51); and a recirculation passage (38) connecting the inlet passage (45) and the outlet passage (53). In a cross-sectional view along an axis of the impeller (2), the intake air introduction portion (5) has: a front-side surface (6) defining a front side (XF) in the outlet passage (53), the front-side surface (6) being inclined to a rear side (XR) from an outer side toward an inner side in a radial direction (Y); a rear-side surface (7) defining the rear side (XR) in the outlet passage (53), the rear-side surface (7) being inclined to the rear side (XR) from the outer side toward the inner side in the radial direction (Y) and including a convex curved portion (71) formed into a convex curved shape at least in part; and a front-side introduction surface (8) formed on the front side (XF) relative to the outflow port (52) on the introduction surface (51), the front-side introduction surface (8) being inclined to the rear side (XR) from the outer side toward the inner side in the radial direction (Y) and including an introduction surface-side convex curved portion (81) formed into a convex curved shape at least in part.

With the above configuration 1), since each of the front-side surface (6) and the rear-side surface (7) defining the outlet passage (53) is inclined to the rear side (XR) from the outer side toward the inner side in the radial direction (Y), the outlet passage (53) can turn the recirculation flow (RF) passing through the outlet passage (53) such that a velocity component toward the rear side (XR) in the axial direction is increased and a velocity component toward the inner side in the radial direction is decreased. Since the rear-side surface (7) includes the convex curved portion (71) formed into the convex curved shape at least in part, it is possible to produce an effect of drawing in the recirculation flow (RF) by the Coanda effect. Thus, it is possible to suppress that the recirculation flow (RF) flowing out to the intake air introduction path (50) separates from the rear-side surface (7), and it is possible to effectively turn the recirculation flow (RF) in the outlet passage (53).

Since the velocity component of the recirculation flow (RF) flowing out to the intake air introduction path (50) toward the rear side (XR) in the axial direction is increased by turning the recirculation flow (RF) as described above, it is possible to suppress the occurrence of the backflow in the vicinity of the shroud surface (41). Further, since the velocity component of the recirculation flow (RF) flowing out to the intake air introduction path (50) toward the inner side in the radial direction is decreased by turning the recirculation flow (RF) as described above, it is possible to suppress the interference between the main flow (MF) flowing through the intake air introduction path (50) toward the rear side (XF) and the recirculation flow (RF) flowing out to the intake air introduction path (50), and it is possible to reduce the pressure loss of the main flow (MF) or the recirculation flow (RF). Thus, with the above configuration 1), it is possible to suppress the occurrence of the pressure loss of the fluid in the compressor housing (3) and improve the efficiency of the centrifugal compressor (1).

Further, with the above configuration 1), the front-side introduction surface (8) is inclined to the rear side (XR) from the outer side toward the inner side in the radial direction (Y), and includes the introduction surface-side convex curved portion (81) formed into the convex curved shape at least in part. In this case, it is possible to suppress the pressure loss due to collision of the main flow (MF) flowing through the intake air introduction path (50) to the rear side (XR) with the front-side introduction surface (8).

2) In some embodiments, the compressor housing (3) as defined in the above configuration 1), wherein the front-side surface (6) includes a concave curved portion (61) formed into a concave curved shape at least in part.

With the above configuration 2), the front-side surface (6) includes the concave curved portion (61) formed into the concave curved shape at least in part. In this case, since the recirculation flow (RF) passing through the outlet passage (53) is guided by the concave curved portion (61), it is possible to effectively turn the recirculation flow (RF) in the outlet passage (53). Thus, it is possible to effectively suppress the occurrence of the backflow in the vicinity of the shroud surface (41), and it is possible to effectively suppress the pressure loss of the main flow (MF) or the recirculation flow (RF) due to the interference between the main flow (MF) and the recirculation flow (RF).

3) In some embodiments, the compressor housing (3) as defined in the above configuration 1) or 2), wherein the convex curved portion (71) of the rear-side surface (7) is formed at a position including at least a rear-side end (72) of the rear-side surface (7), and a tangent direction of the convex curved portion (71) passing through the rear-side end (72) coincides with an extension direction of a rear-side introduction surface (9) formed on the rear side (XR) relative to the outflow port (52) on the introduction surface (51).

With the above configuration 3), the tangent direction of the convex curved portion (71) passing through the rear-side end (72) coincides with the extension direction of the rear-side introduction surface (9) formed on the rear side (RF) relative to the outflow port (52) on the introduction surface (51). In this case, the convex curved portion (71) of the rear-side surface (7) and the rear-side introduction surface (9) can smoothly be connected without any step. Thus, the recirculation flow (RF) flowing through the outlet passage (53) along the convex curved portion (71) can be caused to flow along the rear-side introduction surface (9), making it possible to effectively turn the recirculation flow (RF) in the outlet passage (53), and making it possible to effectively suppress the occurrence of the backflow in the vicinity of the shroud surface (41).

4) In some embodiments, the compressor housing (3) as defined in any one of the above configurations 1) to 3), wherein a relationship of R3>R1 is satisfied, where R1 is a radius of curvature of the convex curved portion (71) on the rear-side surface (7), and R3 is a radius of curvature of the introduction surface-side convex curved portion (81) on the front-side introduction surface (8).

With the above configuration 4), since the radius of curvature R1 of the convex curved portion (71) on the rear-side surface (7) is smaller than the radius of curvature R3 of the introduction surface-side convex curved portion (81), it is possible to effectively turn the recirculation flow (RF) in the outlet passage (53). Thus, it is possible to effectively suppress the occurrence of the backflow in the vicinity of the shroud surface (41), and it is possible to effectively suppress the pressure loss of the main flow (MF) or the recirculation flow (RF) due to the interference between the main flow (MF) and the recirculation flow (RF).

5) In some embodiments, the compressor housing (3) as defined in the above configuration 2), wherein a relationship of R2>R1 is satisfied, where R1 is a radius of curvature of the convex curved portion (71) on the rear-side surface (7), and R2 is a radius of curvature of the concave curved portion (61) on the front-side surface (6).

With the above configuration 5), since the radius of curvature R2 of the concave curved portion (61) on the front-side surface (6) is larger than the radius of curvature R1 of the convex curved portion (71) on the rear-side surface (7), it is possible to alleviate the rapid reduction in passage area of the outlet passage (53) at the inlet side, making it possible to reduce the pressure loss of the recirculation flow (RF) passing through the outlet passage (53).

6) In some embodiments, the compressor housing (3) as defined in the above configuration 2), wherein a relationship of R3>R2>R1 is satisfied, where R1 is a radius of curvature of the convex curved portion (71) on the rear-side surface (7), R2 is a radius of curvature of the concave curved portion (61) on the front-side surface (6), and R3 is a radius of curvature of the introduction surface-side convex curved portion (81) on the front-side introduction surface (8).

With the above configuration 6), since the radius of curvature R1 of the convex curved portion (71) on the rear-side surface (7) is smaller than the radius of curvature R3 of the introduction surface-side convex curved portion (81), it is possible to suppress the interference caused when the main flow (MF) flowing through the intake air introduction path (50) joins the recirculation flow (RF) flowing out from the outlet passage (53) to the intake air introduction path (50). Thus, it is possible to reduce the pressure loss of the main flow (MF) or the recirculation flow (RF). Further, since the radius of curvature R2 of the concave curved portion (61) on the front-side surface (6) is larger than the radius of curvature R1 of the convex curved portion (71) on the rear-side surface (7), it is possible to alleviate the rapid reduction in passage area of the outlet passage (53) at the inlet side, making it possible to reduce the pressure loss of the recirculation flow (RF) passing through the outlet passage (53). Thus, with the above configuration 6), since the main flow (MF) or the recirculation flow (RF) with the small pressure loss in the intake air introduction path (50) or the outlet passage (53) can be sent to the impeller (2), it is possible to effectively improve the efficiency of the centrifugal compressor (1).

7) In some embodiments, the compressor housing (3) as defined in any one of the above configurations 1) to 6), wherein, in a cross-sectional view along an axis (CA) of the impeller (2), a relationship of t1>t2 is satisfied, where t1 is a passage width of the inlet passage (45) in the inflow port (44), and t2 is a passage width of the outlet passage (53) in the outflow port (52).

With the above configuration 7), since the passage width t2 of the outlet passage (53) in the outflow port (52) is larger than the passage width t1 of the inlet passage (45) in the inflow port (44), it is possible to increase the flow velocity of the recirculation flow (RF) passing through the outflow port (52) of the outlet passage (53). Since the flow velocity of the recirculation flow (RF) introduced to the intake air introduction path (50) is increased, it is possible to increase the effect of suppressing the backflow in the vicinity of the shroud surface (41) by the recirculation flow (RF).

8) In some embodiments, the compressor housing (3) as defined in the above configuration 7), wherein the passage width (t) of the outlet passage (53) is formed to be the same throughout the outlet passage (53), or is formed to gradually decrease toward the outflow port (52).

With the above configuration 8), since the passage width (t) of the outlet passage (53) is formed to be the same throughout the outlet passage (53) or is formed to gradually decrease toward the outflow port (52), it is possible to increase the flow velocity of the recirculation flow (RF) passing through the outflow port (52) of the outlet passage (53). Since the flow velocity of the recirculation flow (RF) introduced to the intake air introduction path (50) is increased, it is possible to increase the effect of suppressing the backflow in the vicinity of the shroud surface (41) by the recirculation flow (RF). Further, since the passage width (t) of the outlet passage (53) is formed to be the same throughout the outlet passage (53) or is formed to gradually decrease toward the outflow port (52), it is possible to suppress the rapid reduction in passage area of the outlet passage (53) at the inlet side. Thus, it is possible to suppress the pressure loss of the recirculation flow RF passing through the outlet passage (53).

9) In some embodiments, the compressor housing (3) as defined in any one of the above configurations 1) to 8), wherein a rear-side end (82) of the front-side introduction surface (8) is located on the front side (XF) relative to a front-side end (73) of the rear-side surface (7).

With the above configuration 9), the rear-side end (82) of the front-side introduction surface (8) is located on the front side (XF) relative to the front-side end (73) of the rear-side surface (7). In this case, since the length of the outlet passage (53) can sufficiently be large, it is possible to lengthen the curved portion (for example, the convex curved portion 71 of the rear-side surface 7 or the like) formed on a wall surface defining the outlet passage (53). Since the above-described curved portion is lengthened, it is possible to promote the turning of the recirculation flow (RF).

10) In some embodiments, the compressor housing (3) as defined in any one of the above configurations 1) to 9), wherein a relationship of d3>d1 is satisfied, where d1 is a distance between a rear-side end (72) of the rear-side surface (7) and the axis (CA) of the impeller (2), and d3 is a distance between a rear-side end (82) of the front-side introduction surface (8) and the axis (CA) of the impeller (2).

With the above configuration 10), the distance d3 between the axis (CA) and the rear-side end (82) of the front-side introduction surface (8) is greater than the distance d1 between the axis (CA) and the rear-side end (72) of the rear-side surface (7). In this case, the recirculation flow (RF) is returned to a section of the intake air introduction path (50) where the passage area is reduced (area reduced section), promoting mixture of the recirculation flow (RF) and the main flow (MF), and making it possible to achieve uniformity in a velocity distribution of the fluid introduced to the impeller (2). Thus, it is possible to suppress the occurrence of surging or the occurrence of the backflow in the vicinity of the shroud surface (41).

11) In some embodiments, the compressor housing (3) as defined in any one of the above configurations 1) to 10), wherein a relationship of d3≤d2 is satisfied, where d2 is a distance between a front-side end (73) of the rear-side surface (7) and the axis (CA) of the impeller (2), and d3 is a distance between a rear-side end (82) of the front-side introduction surface (8) and the axis (CA) of the impeller (2).

With the above configuration 11), the distance d2 between the axis (CA) and the front-side end (73) of the rear-side surface (7) is the same as the distance d3 between the axis (CA) and the rear-side end (83) of the front-side introduction surface (8), or greater than the above-described distance d3. In this case, it is possible to prevent the main flow (MF) flowing through the intake air introduction path (50) toward the rear side (XR) and the recirculation flow (RF) flowing out to the intake air introduction path (50) from facing each other. Thus, it is possible to suppress the interference between the main flow (MF) and the recirculation flow (RF), and it is possible to reduce the pressure loss of the main flow (MF) or the recirculation flow (RF).

12) In some embodiments, the compressor housing (3) as defined in any one of the above configurations 1) to 11), wherein a relationship of d1<d3≤d2 is satisfied, where d1 is a distance between a rear-side end (72) of the rear-side surface (7) and the axis (CA) of the impeller (2), d2 is a distance between a front-side end (73) of the rear-side surface (7) and the axis (CA) of the impeller (2), and d3 is a distance between a rear-side end (82) of the front-side introduction surface (8) and the axis (CA) of the impeller (2).

With the above configuration 12), the above-described distance d2 is the same as the above-described distance d3, or greater than the above-described distance d3. In this case, it is possible to prevent the main flow (MF) flowing through the intake air introduction path (50) toward the rear side (XR) and the recirculation flow (RF) flowing out to the intake air introduction path (50) from facing each other. Thus, it is possible to suppress the interference between the main flow (MF) and the recirculation flow (RF), and it is possible to reduce the pressure loss of the main flow (MF) or the recirculation flow (RF). Further, the above-described distance d3 is greater than the above-described distance d1. In this case, the recirculation flow (RF) is returned to the section of the intake air introduction path (50) where the passage area is reduced (area reduced section), promoting mixture of the recirculation flow (RF) and the main flow (MF), and making it possible to achieve uniformity in a velocity distribution of the fluid introduced to the impeller (2). Thus, it is possible to suppress the occurrence of surging or the occurrence of the backflow in the vicinity of the shroud surface (41).

Further, with the above configuration 12), the above-described distance d2 is greater than the above-described distance d1. In this case, it is possible to reduce a swirling velocity component of the recirculation flow (RF) when passing through the outlet passage (53). Thus, it is possible to suppress the interference between the main flow (MF) flowing through the intake air introduction path (50) toward the rear side (XR) and the recirculation flow (RF) flowing out to the intake air introduction path (50), and it is possible to reduce the pressure loss of the main flow (MF) or the recirculation flow (RF).

13) In some embodiments, the compressor housing (3) as defined in the above configuration 10) or 12), wherein the introduction surface-side convex curved portion (81) of the front-side introduction surface (8) is formed at a position including at least a rear-side end (82) of the front-side introduction surface (8), and a virtual arc (VA) including the introduction surface-side convex curved portion (81) is configured to touch the rear-side end (72) of the rear-side surface (7).

With the above configuration 13), since the virtual arc (VA) including the introduction surface-side convex curved portion (81) is configured to touch the rear-side end (72) of the rear-side surface (7), it is possible to cause the main flow (MF) flowing along the introduction surface-side convex curved portion (81) to flow along the rear-side introduction surface (9) connected to the rear-side end (72) of the rear-side surface (7). Further, it is possible to cause the recirculation flow (RF) passing through the outflow port (52) along the rear-side surface (7) to flow along the rear-side introduction surface (9). Thus, the inclination angle of the flow direction of the recirculation flow (RF) with respect to the flow direction of the main flow (MF) can become gentle. Since the inclination angle becomes gentle, it is possible to suppress the interference between the main flow (MF) and the recirculation flow (RF). Since the interference between the main flow (MF) and the recirculation flow (RF) is suppressed, it is possible to effectively suppress the pressure loss of the main flow (MF) or the recirculation flow (RF).

14) In some embodiments, the compressor housing (3) as defined in any one of the above configurations 10) to 13), wherein an inner peripheral surface (381) forming the recirculation passage (38) extends obliquely to an axial direction of the impeller (2) such that a distance from the axis (CA) of the impeller (2) increases from a connection position (382) with the inlet passage (45) toward a connection position (384) with the outlet passage (53).

With the above configuration 14), since the inner peripheral surface (381) forming the recirculation passage (38) is configured such that the distance from the axis (CA) of the impeller (2) increases from the connection position (382) with the inlet passage (45) toward the connection position (384) with the outlet passage (53), it is possible to reduce the swirling velocity component of the recirculation flow (RF) flowing through the recirculation passage (38). Since the swirling velocity component of the recirculation flow (RF) is reduced, it is possible to suppress the interference between the main flow (MF) flowing through the intake air introduction path (50) toward the rear side (XR) and the recirculation flow (RF) flowing out to the intake air introduction path (50), and it is possible to reduce the pressure loss of the main flow (MF) or the recirculation flow (RF).

15) In some embodiments, the compressor housing (3) as defined in any one of the above configurations 1) to 14), wherein a relationship of L≤0.5×D is satisfied, where L is a distance parallel to the axial direction of the impeller (2) between the impeller blade (21) and the rear-side end (82) of the front-side introduction surface (8), and D is a diameter of a leading edge (25) of the impeller blade (21).

With the above configuration 15), the relationship of L≤0.5×D is satisfied. In this case, since the outflow port (52) of the outlet passage (53) is disposed near the impeller blade (21), it is possible to return the recirculation flow (RF) near the leading edge (25) of the impeller blade (21). Thus, it is possible to increase the effect of suppressing the backflow in the vicinity of the shroud surface (41) by the recirculation flow (RF).

16) A centrifugal compressor (1) according to at least one embodiment of the present disclosure includes the compressor housing (3) as defined in any one of the above configurations 1) to 15).

With the above configuration 16), with the above-described compressor housing (3), since it is possible to suppress the occurrence of the pressure loss of the fluid in the compressor housing (3), it is possible to improve the efficiency of the centrifugal compressor (1).

### REFERENCE SIGNS LIST

1 Centrifugal compressor
2 Impeller
3 Compressor housing
4 Shroud portion
5 Intake air introduction portion
6 Front-side surface
7 Rear-side surface
8 Front-side introduction surface
9 Rear-side introduction surface
10 Turbocharger
11 Turbine
12 Rotatable shaft
13 Turbine rotor
14 Turbine housing
15 Bearing
16 Bearing housing
21 Impeller blade
22 Tip
23 Hub
24 Outer surface
25 Leading edge
26 Shroud-side end
31 Intake port
32 Discharge port
33 Scroll portion
34 Scroll passage
35 Inner peripheral surface
36 Impeller chamber
37 Diffuser passage
38 Recirculation passage
41 Shroud surface
42 Shroud-side passage surface
43 Rear-side end
44 Inflow port
45 Inlet passage
46 Front-side end
50 Intake air introduction path
51 Introduction surface
52 Outflow port
53 Outlet passage
61 Concave curved portion
71 Convex curved portion
81 Introduction surface-side convex curved portion
82 Rear-side end
141 Exhaust gas introduction port
142 Exhaust gas discharge port
161 Impeller chamber forming surface
162 Hub-side passage surface
CA Axis of impeller
CB Axis of recirculation passage
MF Main flow
PS Separation space
R1, R2, R3 Radius of curvature
RF Recirculation flow
S1 Tangent line
VA Virtual arc
X Axial direction
XF Front side (in axial direction)
XR Rear side (in axial direction)
Y Radial direction

1. A compressor housing for rotatably housing an impeller of a centrifugal compressor, comprising:
a shroud portion which has a shroud surface facing a tip of an impeller blade of the impeller with a predetermined gap; and
an intake air introduction portion which has an introduction surface formed on a front side of the shroud surface, the introduction surface defining an intake air introduction path for guiding intake air introduced from an intake port of the compressor housing toward the impeller blade,
wherein the compressor housing internally forms:
an inlet passage with an inflow port formed in the shroud surface;
an outlet passage with an outflow port formed in the introduction surface; and
a recirculation passage connecting the inlet passage and the outlet passage, and
wherein, in a cross-sectional view along an axis of the impeller, the intake air introduction portion has:
a front-side surface defining a front side in the outlet passage, the front-side surface being inclined to a rear side from an outer side toward an inner side in a radial direction;
a rear-side surface defining the rear side in the outlet passage, the rear-side surface being inclined to the rear side from the outer side toward the inner side in the radial direction and including a convex curved portion formed into a convex curved shape at least in part; and
a front-side introduction surface formed on the front side relative to the outflow port on the introduction surface, the front-side introduction surface being inclined to the rear side from the outer side toward the inner side in the radial direction and including an introduction surface-side convex curved portion formed into a convex curved shape at least in part.

2. The compressor housing according to claim 1,
wherein the front-side surface includes a concave curved portion formed into a concave curved shape at least in part.

3. The compressor housing according to claim 1,
wherein the convex curved portion of the rear-side surface is formed at a position including at least a rear-side end of the rear-side surface, and
wherein a tangent direction of the convex curved portion passing through the rear-side end coincides with an extension direction of a rear-side introduction surface formed on the rear side relative to the outflow port on the introduction surface.

4. The compressor housing according to claim 1,
wherein a relationship of R3>R1 is satisfied,
where R1 is a radius of curvature of the convex curved portion on the rear-side surface, and
R3 is a radius of curvature of the introduction surface-side convex curved portion on the front-side introduction surface.

5. The compressor housing according to claim 2,
wherein a relationship of R2>R1 is satisfied,
where R1 is a radius of curvature of the convex curved portion on the rear-side surface, and
R2 is a radius of curvature of the concave curved portion on the front-side surface.

6. The compressor housing according to claim 2,
wherein a relationship of R3>R2>R1 is satisfied,
where R1 is a radius of curvature of the convex curved portion on the rear-side surface,
R2 is a radius of curvature of the concave curved portion on the front-side surface, and
R3 is a radius of curvature of the introduction surface-side convex curved portion on the front-side introduction surface.

7. The compressor housing according to claim 1,
wherein, in a cross-sectional view along an axis of the impeller, a relationship of t1>t2 is satisfied,
where t1 is a passage width of the inlet passage in the inflow port, and
t2 is a passage width of the outlet passage in the outflow port.

8. The compressor housing according to claim 7,
wherein the passage width of the outlet passage is formed to be the same throughout the outlet passage, or is formed to gradually decrease toward the outflow port.

9. The compressor housing according to claim 1,
wherein a rear-side end of the front-side introduction surface is located on the front side relative to a front-side end of the rear-side surface.

10. The compressor housing according to claim 1,
wherein a relationship of d3>d1 is satisfied,
where d1 is a distance between a rear-side end of the rear-side surface and the axis of the impeller, and
d3 is a distance between a rear-side end of the front-side introduction surface and the axis of the impeller.

11. The compressor housing according to claim 1,
wherein a relationship of d3≤d2 is satisfied,
where d2 is a distance between a front-side end of the rear-side surface and the axis of the impeller, and
d3 is a distance between a rear-side end of the front-side introduction surface and the axis of the impeller.

12. The compressor housing according to claim 1,
wherein a relationship of d1<d3≤d2 is satisfied,
where d1 is a distance between a rear-side end of the rear-side surface and the axis of the impeller,
d2 is a distance between a front-side end of the rear-side surface and the axis of the impeller, and
d3 is a distance between a rear-side end of the front-side introduction surface and the axis of the impeller.

13. The compressor housing according to claim 10,
wherein the introduction surface-side convex curved portion of the front-side introduction surface is formed at a position including at least a rear-side end of the front-side introduction surface, and
wherein a virtual arc including the introduction surface-side convex curved portion is configured to touch the rear-side end of the rear-side surface.

14. The compressor housing according to claim 10,
wherein an inner peripheral surface forming the recirculation passage extends obliquely to an axial direction of the impeller such that a distance from the axis of the impeller increases from a connection position with the inlet passage toward a connection position with the outlet passage.

15. The compressor housing according to claim 1,
wherein a relationship of L≤0.5×D is satisfied,
where L is a distance parallel to the axial direction of the impeller between the impeller blade and the rear-side end of the front-side introduction surface, and
D is a diameter of a leading edge of the impeller blade.

16. A centrifugal compressor, comprising the compressor housing according to claim 1.
